(19) United States
(12) Patent Application Publication
(10) Pub. No.: US 2025/0068169 A1
(43) Pub. Date: Feb. 27, 2025

(54) METHOD FOR ASSISTING REMOTE DRIVING, AND ASSISTING DEVICE

(71) Applicant: Toyota Jidosha Kabushiki Kaisha, Toyota-shi (JP)

(72) Inventors: Kosuke AKATSUKA, Mishima-shi (JP); Rio Suda, Toyota-shi (JP)

(73) Assignee: Toyota Jidosha Kabushiki Kaisha, Toyota-shi (JP)

(21) Appl. No.: 18/664,502

(22) Filed: May 15, 2024

(30) Foreign Application Priority Data
Aug. 23, 2023 (JP) 2023-135639

(51) Int. Cl. G05D 1/224

(52) U.S. Cl. CPC G05D 1/2247

(57) ABSTRACT

Video information including a plurality of frames acquired by a camera of a mobile body and reference times of the frames is received from the mobile body. A plurality of future frames is generated from each of the plurality of frames by performing alteration processing using prediction information of a set time destination from each reference time of the plurality of frames. The display control of the camera video including the plurality of future frames is performed so that the plurality of future frames is displayed on the display of the terminal operated by the operator at the time when the set time has elapsed from each reference time of the plurality of frames.

### CROSS-REFERENCE TO RELATED APPLICATION

This application claims priority to Japanese Patent Application No. 2023-135639 filed on Aug. 23, 2023, incorporated herein by reference in its entirety.

### BACKGROUND

### 1. Technical Field

The present disclosure relates to a method and a device for assisting remote driving of a mobile body by an operator.

### 2. Description of Related Art

WO 2018/155159 discloses a system for outputting camera video, received from a vehicle, from a remote device. In this conventional system, when communication delay time from the vehicle to the remote device is a first amount of time, a first range is cut out from frames of the camera video and output from the remote device. Also, in the conventional system, when the communication delay time from the vehicle to the remote device is a second amount of time, a second range is cut out from the frames of the camera video and output from the remote device.

The second amount of time is longer than the first amount of time. The second range is a range narrower than the first range. In the output of the first and second ranges, these ranges are expanded in accordance with a size of a display unit of the remote device. Accordingly, when the second range is output, a camera video in which the vehicle appears to have moved forward, as compared when the first range is output, is displayed on the display unit. Thus, the operator can be provided with the camera video in which effects of communication delay are compensated for.

### SUMMARY

In the above-described conventional system, when the communication delay time increases or decreases and crosses a boundary between the first amount of time and the second amount of time many times, the display mode of the camera video is switched. Thus, the display unit flickers over and over again. This leads to fatigue of the operator viewing at the camera images. Accordingly, improvement for suppressing such inconvenience is desired.

An object of the present disclosure is to provide technology capable of suppressing flickering in display of the camera video when the operator is provided with camera video in which effects of communication delay are compensated for.

A first aspect of the present disclosure is a method for assisting remote driving of a mobile body by an operator, and has the following features.

The method includes receiving, from the mobile body, video information including a plurality of frames acquired by a camera of the mobile body and each reference time of the frames,
generating a plurality of future frames from each of the frames by performing alteration processing using prediction information for a point in the future by a set amount of time from each reference time of the frames, respectively, and
performing display control of a camera video including the future frames, such that the future frames are displayed on a display of a terminal operated by the operator at a time when the set amount of time passes from each reference time of the frames, respectively.

A second aspect of the present disclosure is a device for assisting remote driving of a mobile body by an operator, and has the following features.

The device includes a processor that performs various types of processing.

The processor is configured to
receive, from the mobile body, video information including a plurality of frames acquired by a camera of the mobile body and each reference time of the frames,
generate a plurality of future frames from each of the frames, by performing alteration processing using prediction information for a point in the future by a set amount of time from each reference time of the frames, respectively, and
perform display control of a camera video including the future frames, such that the future frames are displayed on a display of a terminal operated by the operator at a time when the set amount of time passes from each reference time of the frames, respectively.

According to the present disclosure, alteration processing is performed using prediction information for a point in the future by a set amount of time from each reference time of the frames, respectively, and the future frames are generated. According to this alteration processing, camera video including the future frames in which effects of communication delay are compensated for can be generated. According to the present disclosure, further, display control of camera video including these future frames is performed, such that these future frames are displayed on the display at a time when the set amount of time passes from each reference time of the frames, respectively. According to this display control, each time a time at which the set amount of time has elapsed from each reference time of the frames arrives, respectively, these future frames can be displayed on the display one after another. Thus, flickering of the display of the camera video in which effects of communication delay are compensated for can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating remote driving according to an embodiment;

FIG. 2 is a flowchart explaining a flow of processing particularly related to the embodiment;

FIG. 3 is a diagram for explaining an estimation example of a position and an orientation;

FIG. 4 is a diagram illustrating a first exemplary processing of S13 of FIG. 2;

FIG. 5 is a diagram illustrating a second exemplary processing of S13 of FIG. 2; and

FIG. 6 is a diagram for explaining effects according to the embodiment.

### DETAILED DESCRIPTION OF EMBODIMENTS

Hereinafter, embodiments of the present disclosure will be described with reference to the drawings. In each figure, the same or corresponding parts are designated by the same reference signs to simplify or omit the description.

### 1. Remote Driving

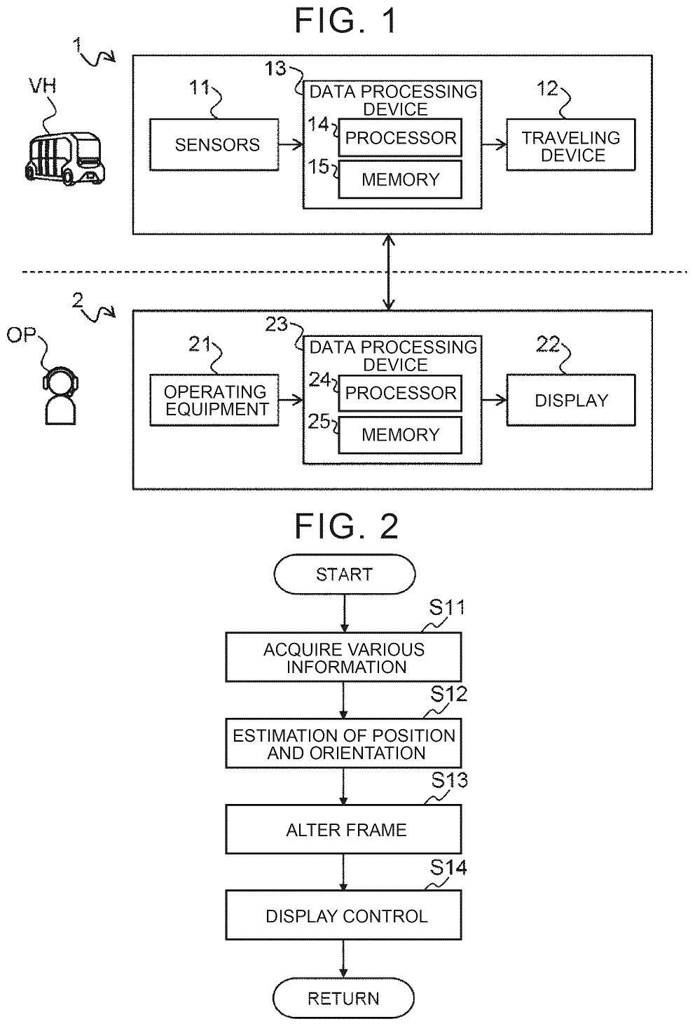

FIG. 1 is a diagram illustrating remote driving according to an embodiment. FIG. 1 is a diagram illustrating an example of an overall configuration of a system related to remote driving. In the example shown in FIG. 1, a vehicle VH as an example of a “mobile body” of the present disclosure is driven (i.e., remotely driven) by an operator OP riding on a remote cockpit 2 as an example of a “remote driving device” of the present disclosure. The vehicle VH and the remote cockpit 2 communicate with each other via a radio network (not shown), for example, and exchange various types of data.

In the embodiment illustrated in FIG. 1, a vehicle system 1 mounted on a vehicle VH includes sensors 11, a traveling device 12, and a data-processing device 13. The vehicle VH is, for example, a vehicle capable of automated driving by the vehicle system 1. The vehicle VH may be a vehicle that can be manually driven by drivers of the vehicle VH. The vehicle VH 1 controls the driving of the vehicle based on various operating amounts of the drivers inputted to the driving device (not shown) of the vehicle VH.

The sensors 11 include a recognition sensor, a position sensor, and a state sensor. The recognition sensor recognizes an ambient condition of the vehicle VH. Examples of the recognition sensor include a camera, a millimeter-wave radar, and a Light Detection And Ranging (LiDAR. The position sensor is configured to acquire position and orientation data of the vehicle VH. Examples of the position sensor include a Global Navigation Satellite System (GNSS) receiver. The status sensor detects a velocity of the vehicle VH, an acceleration (for example, a longitudinal acceleration and a lateral acceleration), a yaw rate, a turning angle of a wheel, a steering angle of a steering wheel, and the like.

The traveling device 12 accelerates, decelerates, and steers the vehicle VH. The traveling device 12 includes, for example, wheels, a motor, a steering device, and a brake device. The motor drives the wheels. The steering system will turn the wheel. The braking device applies a braking force to the vehicle VH. Acceleration of the vehicle VH is performed by control of a motor. The deceleration of the vehicle VH is performed by the control of the braking device. Braking of the vehicle VH may be performed by using regenerative braking by control of a motor. The steering of the vehicle VH is performed by the control of the steering device.

The data processing device 13 is an example of a “mobile body” of the present disclosure. The data processing device 13 comprises at least one processor 14 and at least one memory 15. The processor 14 includes a Central Processing Unit (CPU). The memory 15 is a volatile memory such as a DDR memory. The memory 15 expands various programs used by the processor 14 and temporarily stores various data. The various data includes various data acquired from the sensors 11.

The data processing device 13 communicates with the remote cockpit 2 and exchanges various data with the remote cockpit 2. Examples of various types of data received by the data processing device 13 from the remote cockpit 2 include a request for starting remote driving of the vehicle VH, a control command for remote driving, and the like. The control command includes a drive command, a braking command, and a steering command necessary for controlling the traveling device 12. The control command also includes a command for designating the position of the shift lever of the vehicle VH, a command for operating a travel assistance device such as a headlight of the vehicle VH, or a winker.

Examples of various types of data transmitted by the data processing device 13 to the remote cockpit 2 include a request for remote driving by the remote cockpit 2 (operator OP), data related to the driving environment of the vehicle VH, and the like. The driving environment-related data includes internal data such as a speed of the vehicle VH, an acceleration (deceleration speed), a turning angle of the wheel (or a steering angle of the steering wheel), and external data such as a video of the surroundings of the vehicle VH including at least a video of the front of the vehicle VH.

In the embodiment, data associated with the video of the surroundings of the vehicle VH includes data of respective reference times of a plurality of frames constituting the surrounding video. Examples of the reference time include a time at which a plurality of frames are acquired by the sensors 11, and a time at which these frames are transmitted to the outside of the data processing device 13. Each reference time may not directly indicate a time. For example, it may be a counter that is pre-synchronized between the vehicle VH and the remote cockpit 2 and increments over time. The data of the respective reference times constitute the “video information” of the present disclosure together with the video of the surroundings of the vehicle VH.

The data-processing device 13 performs autonomous driving control and driving assisting control of the vehicle VH. In the automated driving control, for example, the control of the traveling device 12 is autonomously performed on the basis of the driving environment-related information of the vehicle VH acquired from the sensors 11. The driving assistance control includes control of the traveling device 12 based on the control command received from the remote cockpit 2. The driving assistance control also includes control of the traveling device 12 based on the operating inputs of the drivers of the vehicle VH.

The remote cockpit 2 is a device for remote driving by an operator OP. In the example shown in FIG. 1, the remote cockpit 2 includes a driving device 21, a display 22, and a data processing device 23.

The driving device 21 includes various devices for performing remote driving. Various devices include, for example, an accelerator pedal, a steering, a brake pedal, and a shift lever. Various devices include a travel assistance device. Examples of the travel assistance device include an operation lever of a headlight, an operation lever of a winker, an ignition switch, and the like.

Video in front of the vehicle VH is outputted from the display 22. From the display 22, a video of the surroundings of the vehicle VH (for example, a video of the side and the rear of the vehicle VH) other than the video of the front may be outputted together with an image of the front of the vehicle VH. Display 22 may include two or more displays. In this case, for example, a video in front of the vehicle VH is output from the main display, and a video other than the video in front of the main display is output from the sub-display.

The data processing device 23 comprises at least one processor 24 and at least one memory 25. The processor 24 includes a CPU. The memory 25 is a volatile memory such as a DDR memory, and performs expansion of various programs used by the processor 24 and temporary storage of various types of data. The various types of data include video of the surroundings of the vehicle VH and data associated with the video (that is, data of respective reference times). The various types of data also include data related to an operation state of the driving device 21. Examples of the operating state include the amount of depression of the accelerator pedal, the steering angle of the steering wheel, the amount of depression of the brake pedal, and the position of the shift lever. An example of processing performed by the processor 24 will be described later.

### 2. Assisting Remote Driving

FIG. 2 is a flowchart illustrating a flow of processing related to the embodiment. The routine illustrated in FIG. 2 is repeatedly executed by the data processing device 23 (the processor 24) at a predetermined cycle.

In the routine illustrated in FIG. 2, first, various types of information are acquired (S11). Various types of data acquired by S11 are exemplified by various types of data stored in the memory 25. The various types of data include video of the surroundings of the vehicle VH and data associated with the surrounding video. The various types of data also include data related to an operation state of the driving device 21. Note that the data related to the operation state is acquired from the past time that goes back from the current time for a certain time to the current time.

Following S11 processing, the position and orientation are S12. The position and the orientation estimated by S12 are for at least one of the vehicle body and the camera of the vehicle VH in the future of the set-time ST destination from the respective reference times of the plurality of frames constituting the video around the vehicle VH. The set time ST is a fixed value, and any time can be applied to this fixed value (for example, a few milliseconds to a few seconds). If the history of the delay time of the communication between the vehicle system 1 (data processing device 13) of the vehicle VH and the remote cockpit 2 is available, the set time ST may be determined by referring to the delay time calculated from this history.

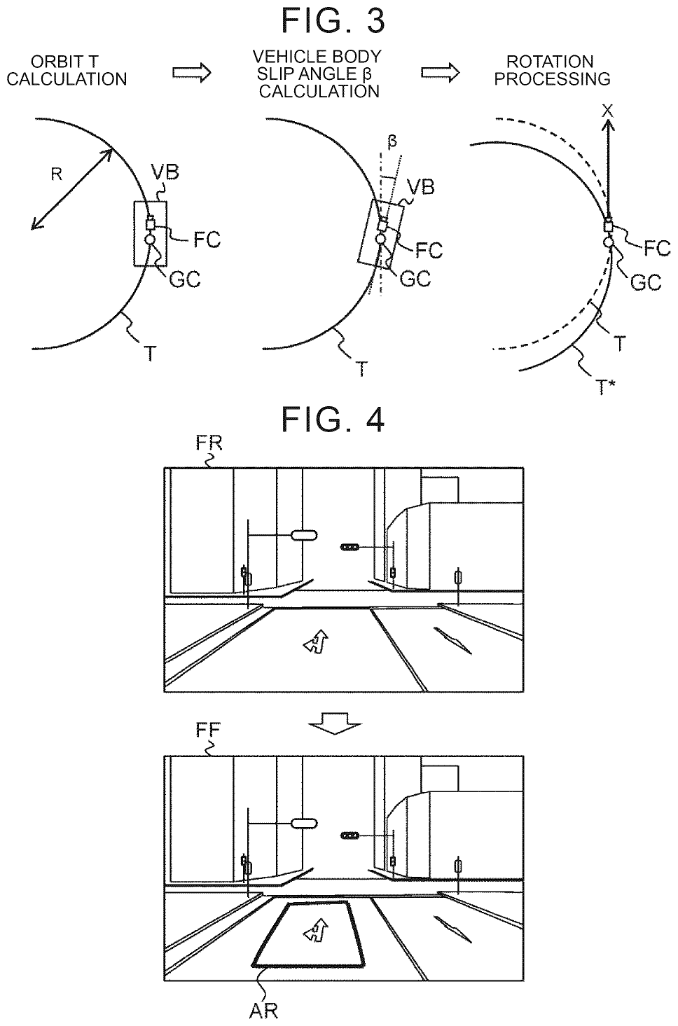

In the following, for the sake of simplicity of explanation, the video around the vehicle VH is assumed to be in front of the vehicle VH. When referring to the camera of the vehicle VH in this case, it is referred to as “front camera FC”. FIG. 3 is a diagram for explaining an estimation example of a position and an orientation. In the embodiment illustrated in FIG. 3, the position and the orientation are estimated on the assumption that VH of vehicles turns in a steady circle from the reference time to the future time of the set time ST destination. It is assumed that the position of the center of gravity GC of the vehicle body VB and the distance from the center of gravity GC to the front-camera FC are known.

Assuming that the vehicle VH turns in a steady circle, the trajectory T of the center of gravity GC drawn by the motion of the vehicle VH can be defined. The radius R of the trajectory T is expressed by the following Equation (1).

$$R = ( 1 + K {V}^{2} ) \times L / δ \qquad ( 1 )$$

In Equation (1), K is a stability factor, V is a vehicle speed, L is a wheel base, and δ is a tire angle.

In the embodiment illustrated in FIG. 3, after the trajectory T is calculated, the slip angle β of the vehicle body VB is calculated. The slip angle β is expressed by the following Equation (2) in which the tire angle δ and the steady gain Gβ of the vehicle body slip angle are set as variables.

$$β = G β \times δ \qquad ( 2 )$$

$$G β = \{ d f ( 1 - {V}^{2} / gLdfCr ) \} / ( 1 + K {V}^{2} ) \qquad ( 3 )$$

In equation (3), df is the front-weight distribution, g is the gravitational acceleration, and Cr is the rear-wheel normalized cornering power CP.

In the example shown in FIG. 3, the trajectory T is rotated after the slip angle β is calculated. The rotation of the trajectory T is performed with the center of gravity GC as a rotation center, and the trajectory T is rotated by an amount corresponding to the slip angle β so that the direction of the front surface of the front-camera FC coincides with the front-rear direction (X direction) of the vehicle body VB.

Between the reference time and the future time of the set time ST destination, the center of gravity GC moves on the rotated trajectory T*. Therefore, the position on the trajectory T* which is separated from the present position of the center of gravity GC by the moving distance calculated by time integration of the estimated vehicle speed Ve (where the vehicle speed Ve is constant) represented by the following Equation (4) is defined as the position of the center of gravity GC after the lapse of the set time ST.

Ve=Vm+Acc×Δt (4)

In Equation (4), Vm is an observation of the vehicle speed V by the vehicle VH status sensor (vehicle speed sensor), and Acc is the present depression amount of the accelerator pedal of the remote cockpit 2. Acc may be the mean of the present depression and that prior to the elapse of the set-time ST.

Since the distance from the center of gravity GC to the front camera FC is known, from the position of the center of gravity GC after the lapse of the set time ST, the position of at least one of the vehicle body VB and the front camera FC after the lapse of the set time ST is estimated. Further, the orientation of at least one of the vehicle body VB and the front-camera FC after the lapse of the set time ST is estimated from the angle formed between the tangent line passing through the position of the center of gravity GC after the lapse of the set time ST and the tangent line passing through the position of the present center of gravity GC.

A second estimation example of the position and the orientation will be described. In this second example, the following equation (5) is used, in which a differential equation relating to the slip angle β and the yaw rate r is arranged into a state equation. (Mathematical formula 1)

$$[ \begin{matrix}\dot{β} \\ \dot{γ}\end{matrix} ] = [ \begin{matrix}{a}_{11} & {a}_{12} \\ {a}_{21} & {a}_{22}\end{matrix} ] [ \begin{matrix}β \\ γ\end{matrix} ] + [ \begin{matrix}{b}_{1} \\ {b}_{2}\end{matrix} ] {δ}_{f} \qquad ( 5 )$$

In Equation (5), of is the steering angle of the steering of the remote cockpit 2. δf may be the mean of the present steering angle and that prior to the elapse of the set-time ST. In Equation (5), a11, a12, a21 and a22 are represented by the following Equations (6) to (9), respectively, and b1 and b2 are represented by the following Equations (10) and (11), respectively.

$$a 11 = - \{ 2 ( K f + K r ) \} / m V \qquad ( 6 )$$

$$a 12 = - 1 - \{ 2 ( L f Kf - LrKr \} / m {V}^{2} \qquad ( 7 )$$

$$a 21 = - \{ 2 ( L f Kf - LrKr \} / Iz \qquad ( 8 )$$

$$a 22 = - \{ 2 ( L f 2 K f + L r 2 K r ) \} / IzV \qquad ( 9 )$$

$$b 1 = 2 Kf / m V \qquad ( 10 )$$

$$b 2 = 2 LfKf / Iz \qquad ( 11 )$$

In equations (6) to (11), Kf is the cornering stiffness of the front wheel, Kr is the cornering stiffness of the rear wheel, m is the weight of the vehicle VH, and Iz is the yaw moment of inertia of the vehicle VH.

In the second embodiment, the slip angle β and the yaw rate r based on the most recent observation by the state sensor (for example, the acceleration sensor and the yaw rate sensor) of the vehicle VH are substituted into the state equation shown in Equation (5). As a result, the slip angle β and the yaw rate r after the lapse of the set time ST are calculated. The integrated value of the yaw rate r between the reference time and the future time of the set time ST destination is the change amount of the yaw angle of the vehicle body VB. Based on the change in the yaw angle, the orientation of at least one of the vehicle body VB and the front-camera FC after the lapse of the set-time ST is estimated. In addition, the time integration of the change amount of the yaw angle and the integrated value of the vehicle speed V is the change amount in the lateral direction of the vehicle body VB, and the change amount in the longitudinal direction of the vehicle body VB is calculated by the time integration of the estimated vehicle speed Ve (where the vehicle speed Ve is constant) expressed by the above equation (4). Therefore, the position of at least one of the vehicle body VB and the front-camera FC after the lapse of the set-time ST is also estimated.

The information on the position and orientation of at least one of the vehicle body VB and the front-camera FC estimated in the first example described with reference to FIG. 3 or the second example described above corresponds to the “prediction information” of the present disclosure.

Returning to FIG. 2, following S12 processing, a plurality of frames constituting a video in front of the vehicle VH are altered (S13). The target of S13 processing is a frame stored in the memories 25 at the time of S13 processing and an unaltered frame. That is, among the frames received by the remote cockpit 2 (the data processing device 23) at the time of S13 processing, a frame that has not been altered once by the processing of S13 of the previous routine is altered in the processing of S13 of the current routine. S13 processing is performed based on the position and orientation data estimated in S12 processing. When S13 processing is performed, a “plurality of future frames” is generated from each of the plurality of frames.

FIG. 4 is a diagram illustrating a first exemplary processing of S13. In FIG. 4, a frame FR of one of a plurality of frames constituting a video in front of the vehicle VH is depicted. In the first embodiment, the augmented reality marker AR is generated based on information on the position and the posture of the vehicle body VB after the set time ST has elapsed from the reference time of the frame FR, and the frame FR is superimposed with the augmented reality marker AR Thus, a future frame FF is generated.

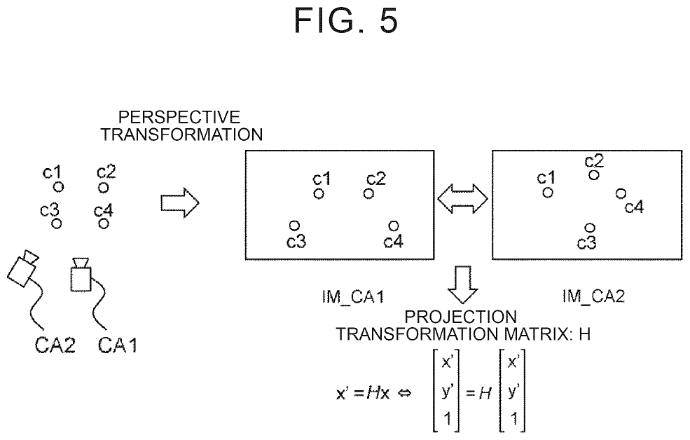

FIG. 5 is a diagram illustrating a second exemplary processing of S13. The second example utilizes a projection transformation. In the projection transformation, first, a c4 is set from the coordinate c1 of four points in the virtual space. Subsequently, a perspective-projection transformation transforms these coordinate c1 into coordinates on the camera images as c4 is captured by the camera CA1 and CA2. Coordinate c1 to c4 on the camera image IM_CA1 and coordinates c1 to c4 on the camera image IM_CA2 shown in FIG. 5 are exemplary coordinates c1 to c4 after the perspective projection transformation.

After c1 to c4 of coordinates after the perspective projection transformation are specified, a projection transformation matrix H of the following equation (12) is calculated between each coordinate x of c1 to c4 on the camera image IM_CA1 and each coordinate x′ of c1 to c4 on the camera image IM_CA2.

x′=Hx (12)

In the second embodiment, the information on the position and the orientation of the front camera FC at the reference time of a certain frame FR is applied to the camera CA1, and the information on the position and the orientation of the front camera FC at the set time ST destination from the reference time is applied to the camera CA2. Then, when the projection transformation matrix H of the above equation (12) is calculated, this projection transformation matrix H is applied to the entire frame FR. Thus, a future frame FF is generated.

Returning to FIG. 2, following S13 processing, a S14 control is performed. In S14 processing, a camera video including a plurality of future frames generated by S13 processing of the previous routine is outputted from the display 22. In outputting these future frames, a plurality of future frames generated by the processing of S13 of the previous routine are rectified. Further, so that this future frame FF is displayed on the display 22 at the time when the set time ST has elapsed from the reference time of a certain future frame FF, control of the output timing of a plurality of future frames generated by the processing of S13 of the previous routine this time is performed.

### 3. Effect

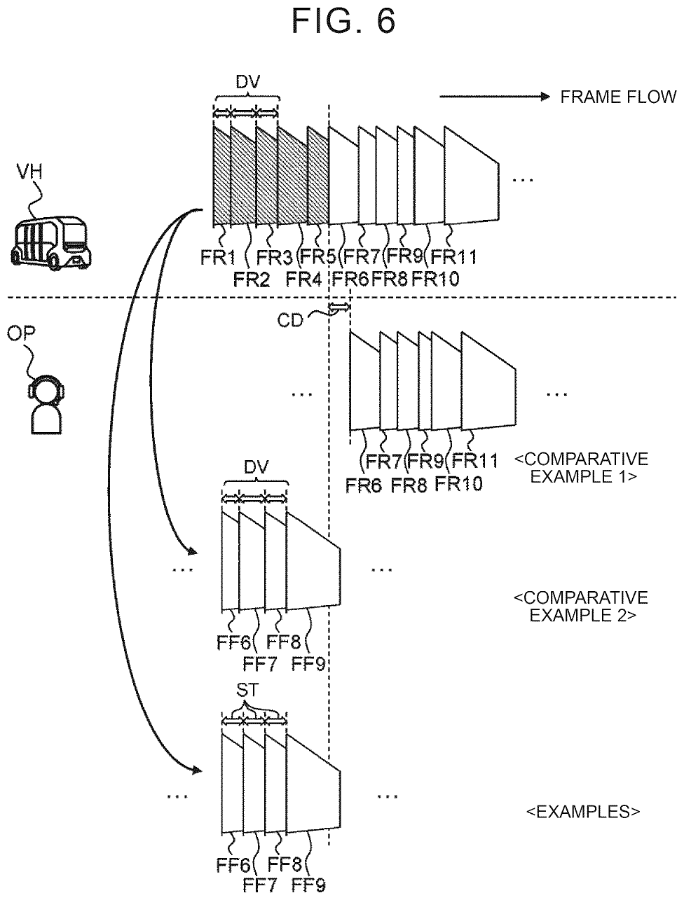

FIG. 6 is a diagram for explaining effects according to the embodiment. In the first stage of FIG. 6, a FR11 is drawn from a frame FR1 as an exemplary frame constituting a video in front of the vehicle VH. The forward video including the frame FR1 to FR11 is outputted from the operator OP (display 22). In “Comparative Example 1” shown in the second row of FIG. 6, the flow of these frames is depicted when these frames FR1 to 11 are outputted as they are. As can be seen from this “Comparative Example 1”, the outputting of the frame FR1 to 11 is delayed by the communication delay CD.

In “Comparative Example 2” shown in the third row of FIG. 6, the flow of these frames is depicted when the frame FF1 to FF11 is generated from the frame FR1 to FR11 in the future by performing the position and orientation estimation processing described in S12 of FIG. 2 and the alteration processing described in S13 of FIG. 2, and is outputted from the display 22. However, in Comparative Example 2, the time at which the remote cockpit 2 receives a plurality of frames is used instead of the reference time. In other words, in Comparative Example 2, FF11 is generated from the future frame FF1 based on the position and orientation of the time of the set-time ST destination from the time when FR11 is received by the remote cockpit 2 from the frame FR1. Therefore, in Comparative Example 2, the distance between the future frame FF1 and FF11 is not equal. This is because the time at which the remote cockpit 2 receives a plurality of frames is used, and thus DV of variation in the communication delay between the plurality of frames is not uniform.

In this regard, according to the embodiment, the processing described in S12 and S13 of FIG. 2 are performed using the reference time. In addition, the displaying control described in S14 is performed. Therefore, as shown in the fourth “embodiment” of FIG. 6, each time a time when the set time ST has elapsed from the future frame FF1 to FF11 reference time has elapsed, these future frames can be displayed on the display 22 one after another. Thus, flickering of the display of the camera video in which effects of communication delay are compensated for can be suppressed.

What is claimed is:

1. A method for assisting remote driving of a mobile body by an operator, the method comprising:
receiving, from the mobile body, video information including a plurality of frames acquired by a camera of the mobile body and each reference time of the frames;
generating a plurality of future frames from each of the frames by performing alteration processing using prediction information for a point in the future by a set amount of time from each reference time of the frames, respectively; and
performing display control of a camera video including the future frames, such that the future frames are displayed on a display of a terminal operated by the operator at a time when the set amount of time passes from each reference time of the frames, respectively.

2. The method according to claim 1, wherein each reference time of the frames includes a time at which each of the frames is externally transmitted from a terminal of the mobile body.

3. The method according to claim 1, wherein
the prediction information includes information of a position and orientation of the camera at a future time in the future by the set amount of time from each reference time of the frames, respectively, and
the alteration processing includes processing of performing projection transformation on each of the frames based on the information regarding the position and orientation of the camera.

4. The method according to claim 1, wherein
the prediction information includes information of a position and orientation of the mobile body at a future time in the future by the set amount of time from each reference time of the frames, respectively, and
the alteration processing includes processing of superimposing an auxiliary image based on the information regarding the position and the orientation of the mobile body on each of the frames.

5. A device for assisting remote driving of a mobile body by an operator, the device comprising a processor that performs various types of processing, wherein
the processor is configured to
receive, from the mobile body, video information including a plurality of frames acquired by a camera of the mobile body and each reference time of the frames,
generate a plurality of future frames from each of the frames, by performing alteration processing using prediction information for a point in the future by a set amount of time from each reference time of the frames, respectively, and
perform display control of a camera video including the future frames, such that the future frames are displayed on a display of a terminal operated by the operator at a time when the set amount of time passes from each reference time of the frames, respectively.
